(19) United States
(12) Patent Application Publication
(10) Pub. No.: US 2004/0262883 A1
(43) Pub. Date: Dec. 30, 2004

(54) Vertical flex trailer hitch

(76) Inventors: James A. Kerins, Willowbrook, IL (US); David Van Vreede, Westmont, IL (US)

Correspondence Address: David Van Vreede, c/o Kerins Industries, Inc., 8408 Wilmette Ave., Darien, IL, 60561, US

(21) Appl. No.: 10/602,105

(22) Filed: Jun. 24, 2003

(51) Int. Cl. B60D 1/00

(52) U.S. Cl. 280/483; 280/506

(57) ABSTRACT

A towing hitch apparatus for allowing limited vertical pivotal movement while diminishing shock or vibration to the vehicle is disclosed. The apparatus consists of a solid steel platform capable of siding into and pivotally coupled to a vehicle mounted receiver tube. Compression devices, disposed opposite one another and attached to said steel platform, are arranged between said steel platform and walls of the receiver tube to allow for limited vertical pivotal movement while absorbing shock or vibration transmitted between a trailer and vehicle.

### CROSS-REFERENCE TO RELATED APPLICATIONS

Non-Applicable

### STATEMENT REGARDING FEDERALLY SPONSORED RESEARCH & DEVELOPMENT

Non-Applicable

### REFERENCE TO SEQUENCE LISTING, A TABLE OR A COMPUTER PROGRAM LISTING APPENDIX

Non-Applicable

### BACKGROUND OF THE INVENTION

The present invention relates generally to an improved trailer hitch of the type that couples a towing vehicle and a trailer. More specifically, the invention relates to a hitch suitable for accommodating ball and socket-type couplings while increasing the vertical deflection angle allowed by a typical coupling device.

An improved vertical flexing trailer hitch, according to this invention, includes a metal platform to which rubber mounts are attached to one end and a hole, positioned and sized, to accept a studded trailer ball, on the other. The design can accommodate a variety of different sized trailer balls.

It has become a very common practice for light commercial trucks, recreational vehicles, SUV's (sport utility vehicles) and automobiles to employ a permanently mounted receiver for towing purposes. The towing package consists of:

(A) a receiver (mounted to the vehicle),

(B) the trailer hitch (attached to the receiver) and

(C) the trailer (attached to the hitch).

(A)—Receiver—This receiver is made up of a 2+″ ID square tube, centered on the rear of the vehicle, and is usually mounted to the frame of the vehicle. The opening of the tube faces rearward and is typically below the vehicle bumper. The tube also has a horizontal 5/16″ hole pre-drilled through it (approximately 5″ from the rear) through which a locking pin is inserted.

(B)—Trailer Hitch—Today's standard trailer hitch is designed for use in conjunction with this permanently mounted receiver. The trailer hitch typically is constructed of a 2−″ OD square tube (with a horizontal 5/16″ hole pre-drilled through it) and a trailer ball attached to it. This trailer hitch (2−″ OD tube) is inserted into the receiver (2+″ ID tube) and locked in place by inserting a locking pin through the aligned horizontal holes. When these two pieces are combined and locked into place, they become rigid and unyielding.

(C)—Trailer—A standard trailer comes with a mechanism, called a coupler, which attaches to the trailer ball. When locked onto the trailer ball, this coupler allows the trailer approximately 15 degrees of upward deflection from horizontal and approximately 7 degrees of downward deflection from horizontal.

One of the basic problems with this type of hitch system is that it does not allow sufficient deflection angles for the many and various ways that trailers are used today. A vehicle and its trailer are originally set up to run on a horizontal surface (flat road) with little flexing or twisting motion. As the vehicle and trailer move from this horizontal symmetry, the difference in position accounted for, hinged, at the point where the trailer is attached to the hitch ball. Unfortunately, the vertical deflection of the typical trailer coupler and ball (approximately 15 degrees upward and 7 degrees downward) is well below that required for many of today's uses (off road, low riding campers and boat launches). A typical example is a boat ramp. Boat ramps can have rather severe angles over a short span. As the trailer is backed onto the ramp and drops below the vehicle's horizontal position, the angle of deflection of the trailer coupler approaches its maximum of 7 degrees. As the trailer is further backed into the water (now horizontal on the lake bottom while the vehicle is on the angled ramp), the angle of deflection reverses and can easily approach the maximum of 15 degrees. If this maximum angle is exceeded, severe pressure is placed upon the vehicle and the trailer. This pressure, increased by a ratio related to the length and weight of the trailer (fulcrum affect), can easily bend the trailer or lighten the weight on the vehicle rear wheels—thus causing sliding and reduced pulling power. Off-road vehicles and recreational vehicles often experience such limitations under similar circumstances.

Our Vertical Flex Trailer Hitch will address this issue of limited deflection by introducing a new hitch design and the use of a rubber cushion at crucial pivot points within the hitch/receiver assembly.

### SUMMARY OF THE INVENTION

The present invention is the first of its kind trailer hitch that provides a cushioned ride and increased vertical angle deflection of up to double that of a traditional hitch. The deflection angle is increased by attaching a compression mechanism (i.e. rubber, springs, etc) to the solid steel trailer hitch shank at crucial pivot points within the receiver. The mechanism slowly compresses under increasing pressure exerted by the trailer thus increasing the total vertical deflection. Vertical Flex Trailer Hitch slides into a standard 2″ ID receiver (assumed to have been previously installed on the vehicle and not part of this patent application) and is secured by inserting a 5/16″ locking pin through an aligned hole in the receiver and hitch.

The advantages of the Vertical Flex Hitch over traditional hitches are threefold. First, the hitch is simple. It has no moving parts and is attached using the same 5/16″ locking pin commonly used in the industry today. Second, the hitch is mounted inside the receiver (assumed to have been previously mounted on the vehicle). Previous attempts to provide additional angle deflection used an external mechanism and many moving parts, thus making it heavy and cumbersome. The Vertical Flex Hitch uses the walls of the receiver to compress a rubber cushion (the compression mechanism of choice) thus slowly providing the increased angle desired. And third, the rubber cushion provides a quieter ride. This rubber cushion replaces the traditional “metal on metal” trailer hitch.

As previously stated, an existing problem of the typical ball trailer hitch is that of limited vertical deflection angles (typical=15 degrees up and 7 degrees down). This invention not only allows for this typical deflection but also includes an added feature, a rubber cushion, whose compression against the walls of the receiver will increase these typical angles by a multiple of at least two. This increased angle allows increased vehicle surface contact at extreme angles and reduces trailer wear and tear.

The object of the invention is to supply a vertical deflection angle greater than that presently allowed by hitches of a similar style, more specifically, those hitches that are hard mounted (steel on steel) within the 2″ receiver.

### BRIEF DESCRIPTION OF THE DRAWINGS

FIG. 1: Side View—This view shows the metal base, the three rubber components, the hole for the locking pin and the hole for the trailer hitch. The rubber components are attached to the metal base and the holes are pre-drilled. The overall dimensions are approximately 2″W×2″H×10″ L.

FIG. 2: Top View—This view shows the radiuses used for the hitch as well as the hole size and position for the trailer ball.

FIG. 3: Demonstration of Flex Hitch in a Receiver—This is a demonstrational drawing only. The drawing shows how the trailer hitch actually fits into a 2″ receiver. The hitch is inserted into the receiver's opening (on the left) until the ⅝″ hole in both pieces are aligned. A locking pin is then inserted through this hole to prevent the hitch from sliding out of the receiver. The extra angle deflection is provided by the compression of the rubber pieces against the walls of the receiver.

FIG. 4: Vertical Flex Hitch and a Typical Vehicle Receiver—Interaction of the Vertical Flex Hitch with a typical vehicle receiver.

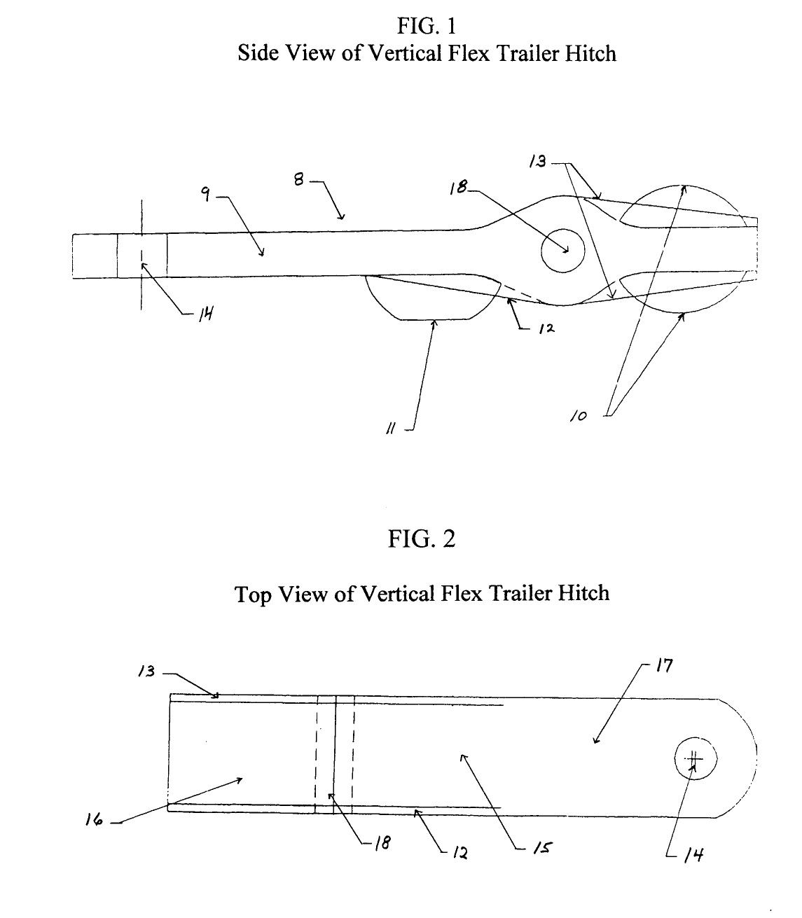

### DETAILED DESCRIPTION OF THE INVENTION

The Vertical Flex Hitch 8 is made up of a solid steel platform 9,17 and compression mechanisms 10,11 (for demonstration, automotive grade neoprene components) that act as shock absorbers similar to rubber bushings used in the auto industry. The positions of the compression mechanisms 15,16 are supported by guide mechanisms 12,13 which is part of the steel platform 9,17. A trailer ball 22 is attached to the hitch through a hole 14 that was predrilled in the steel platform 9 during the manufacturing process. The dimensions of the Vertical Flex assembly are approximately 2″W×2″H×10″ L.

To install, slide the Vertical Flex assembly 8 into a standard 2″ receiver 20,21 (assumed to have been previously installed on the vehicle and not part of this patent application) and secure the hitch by sliding a 5/16″ locking pin 19 through an aligned hole in the receiver and hitch 18. When a trailer is attached to the hitch, the increased weight and/or angle of the trailer will compress the rubber components of the hitch 10,11 against the inside walls of the receiver 21 thus allowing for increased angles of deflection and a quieter ride. To uninstall the Vertical Flex Hitch, a reversal of the foregoing steps is required.

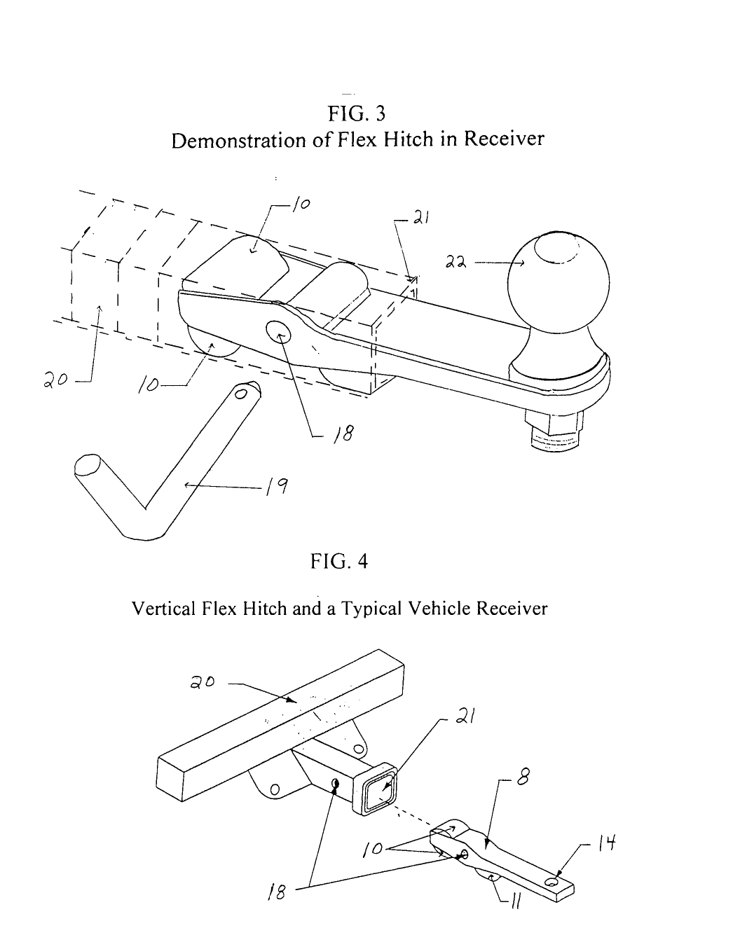

A vital part of this invention is that the rubber compression is going on inside of the 2″ (FIG. 3) compared to other technologies where the mechanism is outside of the receiver.

It is to be understood, however, that various changes and modifications can be made without departing from the true scope and spirit of the present invention as set forth and defined in the following claims. For example, words used in the claims to indicate the compression mechanisms may serve as explanatory purposes and are not meant to limit the scope of the present invention

We claim:

1. A towing hitch apparatus for pivotally connecting the tongue of a trailer to a towing vehicle, said hitch apparatus comprising a solid steel platform for receiving a towing element and adapted to be slidably received into a vehicle mounted receiver tube which has at least one aperture in an outer wall thereof for receiving a retaining means for locking said apparatus to the tube; compression devices, disposed opposite one another and attached to said steel platform and arranged between said steel platform and walls of receiver tube so to allow limited vertical pivotal movement between the receiver and hitch while absorbing shock or vibration transmitted between a trailer and a vehicle.

2. The towing hitch apparatus as defined in claim 1 wherein said disposed compression devices are neoprene.
